(19) United States
(12) Patent Application Publication
(10) Pub. No.: US 2007/0170306 A1
(43) Pub. Date: Jul. 26, 2007

(54) Unity method

(76) Inventor: Eric Rafael Weaver, Tampa, FL (US)

Correspondence Address: Eric R. Weaver, 2008 E Patterson St., Tampa, FL, 33610, US

(21) Appl. No.: 11/322,309

(22) Filed: Jan. 1, 2006

(51) Int. Cl. B64D 45/00

(52) U.S. Cl. 244/1 R

(57) ABSTRACT

This invention defines a Method for managing the psychological and physiological state of an individual person's life. The Method is a conscious perception of the Unity of the universe that we live in; whereby all natural and physical laws are included to understand and solve problems. Utilizing this Method creates conscious control for enhancing decisions by filling the gaps left by the existing sciences.

### BACKGROUND OF THE INVENTION

This patent document contains material that is subject to copyright protection. The copyright owner has no objection to the facsimile reproduction by anyone of the patent documents or the patent disclosure, as it appears in the Patent and Trademark Office file or records, but otherwise reserves all copyrights whatsoever. The copyright owner is not responsible for any attempt to use these methods in any extreme or medical conditions, and hereby assumes no legal liability or responsibility for the accuracy, completeness, or usefulness of any information, apparatus, product, or process disclosed herein without his direct supervision thereof.

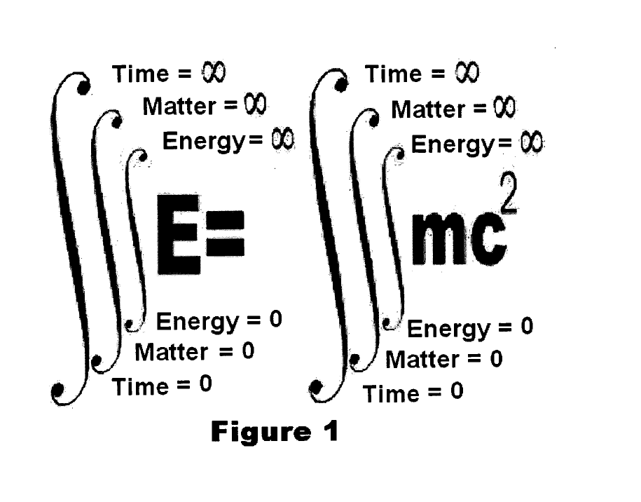

Godel's Undecidability Theorem or the Incompleteness Theorem showed that there are problems that cannot be solved by any set of rules or procedures; instead for these problems one must always extend the set of axioms (Douglas, 1999). This Invention is a Method of using an axiom, FIG. 1, to bridge the gaps of unknowns created by science's endless desire to separate, reduce and define the existence of mankind, where it is humans who compartmentalize science, while nature does not. Science is not the same as knowledge and understanding when morals, ethics, responsibility, emotions and spirit are left out. However, as demonstrated herein science is but a tool to bring understanding of truth=>wisdom.

This Method is based on Bells' Theorem (The EPR Effect) where every charged particle is part of the universe and the universe is part of each charged particle. This implies that each of us, including you and me, are connected together as part of the observable universe (Einstein, Podolsky, & Rosen, 1935)! Understanding the Method of this Invention will utilize this eternal connection and unity in the universe to solve the psychological and physiological problems of an individual person's life.
Einstein's General Relativity (GTR) calculates the density of space-time at each point in space using the density of matter and energy everywhere in the universe. A varying density is referred to as curvature of space. This space density is then used to determine the paths of moving matter and of light which follows the curvature. Archibald Wheeler expressed this: All the matter of the universe tells space what it is and in turn space tells matter how it must move. The feed back loop is the same.
The wave medium—the space around us—is the ONE source of matter and the natural laws. Since the waves of each particle are inter-mingled with the waves of other matter and all contribute to the density of the medium, it follows that every charged particle is part of the universe and the universe is part of each charged particle.
Principle II (extended Mach principle) states that the stars and galaxies of the universe are essential to the laws of Nature and to the existence of the Earth and ourselves. This important fact is not presently familiar to the physics community. For example, the present Standard Model of the universe contain no recognition of Mach's Principle, or our inter-connection with the universe (Wolff & Haselhurst, 2005).

1. Field of the Invention

This invention relates to systems and methods for promoting healthy habits applicable within the fields of emotional intelligence and/or health promotion and disease prevention. This includes systems for generating subliminal messages for the purpose of therapeutically influencing behavior and affecting change the internal personal biology, and circumstances contemplated or externally involved with.

2. Background of Prior Art of the Invention

U.S. Pat. No. 6,497,577 addresses the psychical elements of the human consciousness. Here the energies of the person's emotions are addressed and reconciled with emotions that are conflicting with the person's desire to be happy and productive. The limiting aspect is that it is only concerned about the internal emotional energies involved with human development. The current invention addresses all the psychological and physiological aspects of an individual person's life linked with the universe.

U.S. Pat. No. 5,312,114 is a physical apparatus to supplement decision making with audio and visual cues to enhance imagination of alternatives. Here individuals are accessing current images and conscious thoughts generated by the positive and negative response to their current images about a subject. This is limited by not including any new images or inspiring thoughts to direct the imagery beyond self imposed boundaries. The current invention is based on the formulation of a limitless construct which includes all matter and energy variations throughout time and space to direct imagery to new solutions.

U.S. Pat. No. 5,151,080 is an auditory method for inducing a relaxed meditative state. Here the device is limited by the conception of the users and programmers. They can enter subliminal messages to induce feelings and sensations for new conceptualizations but are not linked to any suitable construct for developing solutions. The current invention similarly requires a meditative state, but then also induces a fundamental conceptualization which spontaneously reacts to the current psychological and physiological aspects of an individual person's life to create new innovative solutions.

### SUMMARY OF THE INVENTION

All evolutionary processes through negative entropy seek to become more complex refining control over energy to develop away from chaos toward order. Mankind tries to understand these evolutionary processes with the natural and physical laws discovered on earth. Consciousness understanding itself is the fulcrum, apex, summit of this evolutionary growth we are now experiencing in today's Scientific Paradigm. We can accept the particle that is then a wave, but we can not understand that Planck's Time is between these, just as before the Particle of the Big Bang was the Superstring or energy Wave of Consciousness intending it. These conceptions are a result of this Method's Unity Perspective since “The properties of the universe must be compatible with the existence of humankind” (Dyson, 1979).

Everything in this universe is based on unity. Newton unified Heaven and Earth recognizing how the apple falling to the earth moves by gravity like the moon's orbit around the earth. Maxwell showed how electricity and magnetism were unified in the electromagnetic field. Then he discovered how electromagnetic waves were also light waves unifying optics to these concepts as well. Then Einstein unified time and space showing again how the universe tends to unity.

Consciousness is the uniform vibration of energy which can be empirically observed, quantified, measured and recorded through this Method repeatedly for intersubjective verification. All energy and matter exhibit consciousness observed through vibrational waves which travel uniformly through everything (Heyman, 2005). The integral of Einstein's energy equation e=mcˆ2 defines how energy is related and connected to matter and time.

With the conception of the unity in this equation this new Method is applied. No attempt to define the physical expressions or “solve” the mathematics is necessary. Simply choosing it accept this new Method creates a fundamental paradigm shift in the DNA structure of the human mind and body to enable new solutions throughout the physical expressions of the mind and body. Accordingly, making this choice has an affect on our universe just like a pebble tossed into the pond changes the water in the pond. We observe this by watching the ripples in the water. This changes the formation and behavior of the pond. Constantly the water moves and stirs the base beneath the surface. So too, this human choice can have a similar effect on everything within and outside of the individual human.

If you are competent in the arts in this area, the conception of the first integral in FIG. 1 represents a summation of an energy area. The second integral represents a summation of the two dimensional areas, creating a three dimensional volume. Then the third integral represents a summation of the three dimensional volumes over the entire 4 dimensional space-time continuum creating a conception of universal unity.

Your consciousness understands that this concept of an energy summation includes components of all matter and all energy in the physical area of your body. You will also understand how the volume represents a broader truer conception of all the components of matter and energy throughout the space around you. Finally taking this third integral over all time includes the energy and matter throughout the space-time continuum experience of your entire lifetime. This last summation could be conceived as your memory, where your mind has recorded all the matter and energy fluctuations you have witnessed in the space around you for your entire lifetime. Including complete experience is not easily discernible by mortal men, however remember that each choice we make is determined by our mind based on the entire history of our individual lives. The logic of this interpretation of FIG. 1 is reasonable and any conscious mind will accept this progression as a suitable definition of universal unity through the integral of this equation: e=mc².

The fundamental paradigm shift that takes place in the DNA with the mind conceiving this Method begins spontaneously. DNA structures represent a cumulative history of the evolution of life. Every element of the evolution of mankind is recorded in the DNA as a vibration of an electron, quantum or string. Every living being has this structure and memory of all the matter energy relations throughout history including this Method inside of their DNA already. Recognizing this Method causes the memory of these fundamental matter/energy structures to become activated in the current psychological and physiological state of an individual person's life.

Once the mind perceives these fundamental matter/energy structures recorded in the DNA, the consciousness is opened to the Unity Perspective to solve problems through the Methods disclosed herein.

### BACKGROUND

Energy can be measured and studied. Consciousness is Energy. Everything is represented by this equation. Everything is Consciousness, everything is God's Consciousness, everything is Love, and everything is this One Same Energy of Creation. As Creation, as God, we ALL seek to create and express with this Energy of Creation to create more Love. This is the conception of this Method. The ideal energy of creation is defined by our “Consciousness of Love,” as taught by the Way of Jesus Christ.

Through this Method, consciousness is directed to a conception which is primal knowledge recorded in our DNA structure. The Unity Method allows the vibration of the individuals conscious to get in-sync with the primal vibrations of their own DNA structures. We attain the full power of this Method, by “loving this truth” shared herein. DNA is the knowledge or instructions and rules the body, our individual consciousness has evolved from this body and “lost direct conscious control of it” while pursuing all the external knowledge in the sciences of Earth. When we consider this Method we again get in-sync with this primal knowledge of the body; creating the ideal environment for evolution=growth=development, and solution of psychological and physiological problems in an individual person's life.

### BRIEF DESCRIPTION OF DRAWINGS

The invention can be best understood by those having ordinary skill in the art by reference to the following detailed description when considered in conjunction with the accompanying drawings in which Einstein's energy equation in integrated:

### DETAILED DESCRIPTION OF DRAWING

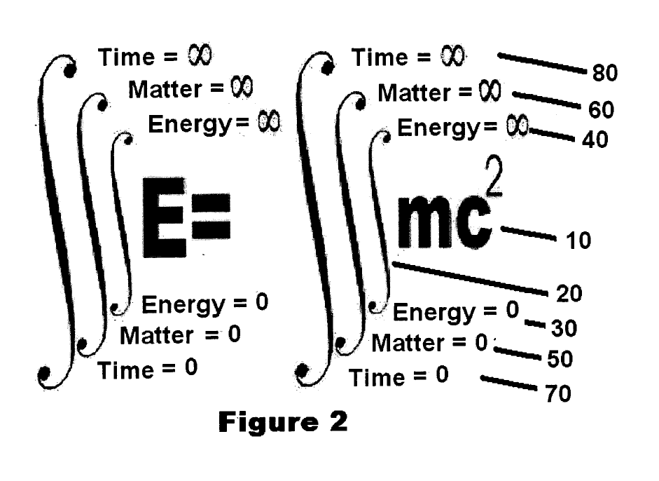

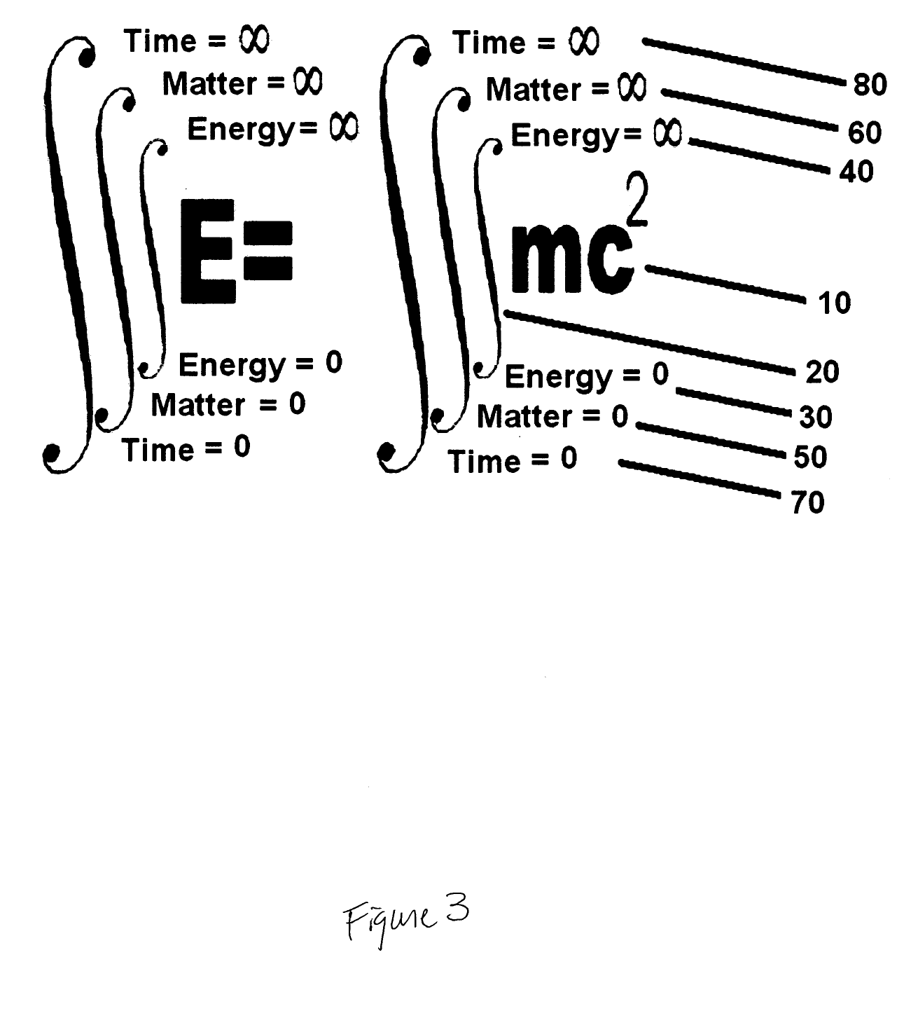

Referring to FIG. 2 Einstein's energy equation 10, e=mc²; represents the fundamental relationship of energy and matter on Earth which functions to create all the current psychological and physiological states of life. The first integral 20 is from energy equal to zero 30, to energy equal to infinity 40. The second integral is from matter equal to zero 50, to matter equal to infinity 60. The third integral is from time equal to zero 70, to time equal to infinity 80. This new conception is the Unity Method, the unity of creation, the Source of Consciousness and the Mind of God.

### Detailed Description of Preferred Embodiment

Fundamentally consciousness represents an energy stream. The Method creates the environment for the consciousness to expand increasing this energy stream. By loving new connections and ideas for dealing with any psychological and physiological state of an individual person's life we are allowing ourselves to consider this fundamental perception of Unity in God. Detailed below are three different psychological or physiological “problems” solved by this Method disclosed.

Consider a “Headache”

Your brain is throbbing, you had a long week and are running late to work and just got a flat tire. You feel like someone is you pounding on your head with a sledge hammer. You might even experience the “white throbbing” sensation that accompanies migraine headaches. However, now conceive of the headache through this Method and recognize the unity of your own brain and body where they are only reacting to stimuli you have focused them on. When considering this Method in relationship to the immediate problem of the headache; you recognized that your consciousness is always in control of the mind and body, there is only one energy stream in your body=your own will power.

Now you choose to visualize this problem in a new way. You see this big white hammer pounding on the front of your head as a “picture.” It is like a movie picture flashing on the wall of your head. Now you choose to focus on this picture throbbing on the wall of your head, and decide to redecorate this room. You see yourself walk across the inside of your head and grab that picture on the wall and through it out the window. Simultaneously you imagine the wadded up picture flying out your ear to land on the floor next to you.

Stop and notice now; your headache is gone. This simplistic example is perceived, understood and recognized instantly. Most people initially get a flash of “no headache” but then they are stunned and fall back into the familiar feeling of having no control and returning to their “headache.” However, when accepting the conscious understanding of how everything is connected and related as defined by this Method; this simplistic insight and conscious exercise will end your headache. Seeing yourself in control allows yourself to take control. You are conscious of the energy moving through your nerves and brain and have decided to change the flow of your own energy. That fleeting moment you felt with “no headache” can simply be focused on and expanded. I almost never get headaches, and might get sick once a year. However, I simply remove this energy from my system and return to peace and comfort easily.

This is an improvement on the prior art of having no control over oneself and taking an aspirin, where mass media has programmed you to believe the drug will relieve your headache, while experiments have shown patients will respond and be relieved with just a sugar pill as well. This Placebo Effect is the unconscious version of this Method (Nordenberg, 2000).

Consider Major Health Issue

You consider that there is a potential for some serious ailment in your body: kidney stones, gal bladder, appendicitis, heart disease or cancer; because of a family history or other psychological or physiological problems in your life. You decide to conceive of this ailment through this Method. Now you consider how there are energy meridians in the body exemplified by the association to acupuncture. There are also blood vessels and nerves along these same paths throughout your body. You recognize that the motion of electrons in wires creates magnetism, similarly the motion of fluids in pipes create friction. You understand all these different masses and energies inside of your body are related by the same unity of the energy equation as in this disclosed Method.

The spontaneous insight is to utilize the induced deep state of consciousness to feel all these energies and motions inside as supporting and purifying themselves through your own direction as perceived through this Method. Therefore you perform rudimentary exercises mindfully to expand this conscious understanding=>seeing and feeling this energy traverses the body to create healing. Ideally this will include a unity of esoteric practices:
a) You study the Siddha Yoga and Kriya Yoga to ignite a quantum self-transformation to higher states of consciousness (Schnell, 2003).
b) You learn Reiki Traditions to Heal and open the energy pathways in the body (Cooper, 2003).
c) You do Kundalini Yoga to straighten and align the energy pathways of the body (Gururattan Kaur Khalsa, 2003).
d) You do Tai Chi healing sound vibrations to clear and tune the energy pathways of the body (Chia, 1986).
e) You complete above exercises a-d for a time period long and sufficient enough for stability and unity through this method. Then you to bring the energy of the earth up to the heavens through the Temple of God (1_Corinthians, 3:16) as defined in ancient Mayan Shamanic practices (Rivera, 2004) to clear the body of all possible ailments.

The first noticeable change will be the xiphoid process, the lowermost tip of the sternum, will spring forward. Energy moves in a circular fashion through the body and the movement of this bone will accent it. Here this Method has found the purpose to this part of the anatomy which scientists currently consider “useless.” Other things will begin to change and shift internally based on your conscious focus during this exercise. This will include correction of health issues internally if so focused. Other possible changes include age, physical events, and physical properties of matter. This conceptualization is the process Jesus Christ used to transfer energy and matter for healing the sick and the lame.

This is an improvement on the prior art of having no control over oneself and relying on a doctor or some medical establishment to keep you healthy as coerced by mass media for a profit.

Consider the DNA of AGE

When skilled in this art considering this Method creates a spontaneous conscious connection between the vibration of the brain to the vibration of the DNA. This can be easily seen by viewing this standard genome sequence graphic (Human Genome, 2005). When scrolling through the graphic on the computer screen you can conceive that you are seeing the sequence of your own DNA. By allowing this graphic to meld with the conception of the Equation in FIG. 2, you will conceive that the evolution of DNA has allowed mankind to record this genome in such a language that your DNA would benefit the most from.

There is Unity, where DNA has evolved to teach DNA how to evolve. This genome sequence is the DNA knowledge of all living energy and experience on the Earth, telling your current conception of DNA the secrets of life. Therefore, the visual scrolling of the genome creates a graphic of the three dimensional helix whereby you are looking inside your own DNA. Your DNA is intuitively reading this sequence of your DNA. Those skilled in this art often get the experience of being dizzy viewing this helix graphic spinning around before them when scrolling down through this graphic.

In so doing you now have consciousness of the true expression and purpose of your own DNA. Your DNA is a recording of your beingness, as well as the instructions for your growth and future beingness. You now decide to remember the experience and beingness during an event while you were age 21. The joy and bliss of BEING 21 and comprehending this Love and experience that is recorded in this DNA brings the fullness of this time into your heart. You can feel and remember the Love and Joy experienced now in your being in Unity with your own DNA at the age of 21.

You now recall this Unity Method conception and acknowledge that your DNA has the memory and capacity to reproduce and recreate this time and experience in the next cell division necessary for your life now. Again recognize that your mind is in control of your body and the fullness of all the energies experienced in your being is now understood through this Method. Therefore, you decide that all your cells will reproduce the love and joy you feel in memory of being 21 the very next cell division your DNA experiences. Further, through this method, you decide that this new direction your mind has provided to your body, will be as basic and fundamental an instruction, for the future of your body as breathing. The DNA will now always create new cells in the love and joy of 21 just as it is able to breathe and know it is breathing (Erix, 2003a).

This is an improvement in the prior art of mass media and medicine programming consumerism, degradation and disposal of life and materials for the progress of their greed. The new Method allows for Age to progress more slowly. The total elimination of eons of training and experience which dictated time bringing age, degradation and disposal will take years to totally erase from human consciousness. Such an erasure will be necessary before man may retain immortal natures again (Erix, 2003c).

Consider Communication with other Life

This conscious connection through the Unity Method was achieved spontaneously as an action between a father and a Son, Christopher Allen. This following discourse is an example where the Father described the event to a friend (Erix, 2003b).

A month or two back I was picking up my kids from school. It's across town and they get out an hour apart. So I figured I'd bring the kayaks and goof around in the river by their school, until my daughter got out. So my son and I got out into the water and paddled down this little channel. As we went along, every now and again, we'd come to a log covered with turtles . . . and they'd all jump into the water to hide as we got closer to them.

Soon we stopped for a moment, and were facing each other on opposite sides of the channel. So I said:
“Hey Chris, what do you feel?”
“Nothing.”
“No I mean really, what do you feel”
“What? nothing dad . . . !”
“Really feel yourself . . . deep down . . . . What do you really feel”
“Ok dad, still nothing!!!”
“Ok now look over there,” and I pointed out another log covered with turtles . . . .
“So now Chris, what do you feel . . . ?? do you feel the change . . . ?? What has changed inside of you? Do you feel it?”
“yeaaayyy??!!”

“That's your connection to the turtles, that's their part of God inside of you. That's where you can go to communicate to the turtles . . . they can feel that too, share with them from down there”

“Oh cool;” was the last thing he said . . . and then we paddled up to them . . . and they all jumped into the water, except one . . . So I turned back to my son.

“Oh Chris, you need to talk to all of them, not just one” . . . .

And the Smile on his face, just popped up from ear to ear . . . Wow, was that an awesome experience. I mean to really teach something. so deep and meaningful, where he completely understood it, and put it into practice right then! I've never had anyone listen, believe, or understand anything I said so well (Erix, 2003b).

I claim:

1. A Method for managing the psychological and physiological state of an individual person's life by inducing and establishing a Unified Perception in human consciousness with a unified energy vibration of consciousness (Heyman, 2005) coinciding with the unity of the universe:
a) A deepened state of consciousness, where a human is psychically and physically relaxed, is attained through meditation, yoga, exercise, hypnosis, medication or other prescribed techniques;
b) A conscious focus is placed on a visual conception of Einstein's Equation FIG. 1, whereby the physical relationship of matter continuously transferred into energy and visa-versa is interpreted;
c) The mathematical and physical conception of the integration of Einstein's Equation is considered, whereby the uniform distribution of matter and energy transformations are recognized as universal and continuous throughout space and time is envisioned.
i. This may or may not include the specific mathematical understandings of integration including:
1. The continuous dynamics of energy and matter transferring from particles to waves.
2. The continuous dynamics exhibited at different vibrations and intensities for each type of energy.
3. The continuous dynamics exhibited at different densities and speeds for each type of matter.
4. The continuous dynamics exhibited at every possible time frame can also be perceived. Time and space are both elastic and relative so allowing the conceptions to leap beyond time into future, past and present can enhance this method.
ii. NO mathematical understandings are necessary where simply appreciating that every possible formation of energy and matter throughout space and time is so designated with this equation.
d) A deep meditative state on the Equation of FIG. 1 is attained as a Unity Perception.

2. A method defined by claim 1 wherein the current psychological and physiological of an individual person's life is considered to be uniformly manifested through this Unity Perception of Equation 1.
a) Specific events and issues involved in the current psychological and physiological of an individual person's life is considered through conception of this Unity Perception.
i. The current experience is a manifestation of the unity of the universe seen in the Equation FIG. 1.
ii. The current experience is defined by this Unity Perception in Equation, FIG. 1.
iii. The current experience and the Unity Perception in Equation, FIG. 1, are both the same experience.
b) A conceptual link in perceived between the Unity Perception of fundamental formations of energy, matter throughout space and time (FIG. 1) and the current psychological and physiological state of an individual person's life.
c) This link between the Unity Perception (FIG. 1) and the current psychological and physiological state of an individual person's life is recognized as valid, true, useful, purposeful, and intrinsic to growth, evolution and life itself.
d) This link is perceived visually in the mind (e.g. third eye) as a physical interchange between energies.
i. This conception may be visualized as a river flowing into an ocean where the water mix and coexist.
ii. The conception may be envisioned as paints mixing, red and blue becoming purple while the intrinsic qualities of the paint still remain the same.
iii. This conception may be perceived as an interplay or dance of light and/or magnetism.
iv. This Unity conception may be considered as the letters E M C² and D N A dancing together like they were alive like in a Sesame Street cartoon on TV.

3. A method of claim 1 & 2 wherein the interchange and dynamics of the Unity Perspective is allowed to evolve new relationships and conceptual properties recognizable as solutions and benefits from the current psychological and physiological state of an individual person's life.
a) The mind watches the dynamic exchange between the Unity Perspective and the current psychological and physiological state of life.
b) The consciousness is allowed to visualize alternative solutions and possible manifestations of the current psychological and physiological state of an individual person's life.
c) The consciousness chooses to enact one of these visualized alternatives to “solve” the current psychological and physiological state of an individual person's life.

4. A method of claim 1, 2 and 3 wherein an audio and/or video device is used to dynamically present these concepts to an individual.

5. A method of claim 1, 2 and 3 wherein a third party or instructor verbally directs each step. Equivalent elements can be substituted for the ones set forth that they perform the same function in the same way for achieving the same result.
